(19) United States
(12) Patent Application Publication
(10) Pub. No.: US 2008/0199198 A1
(43) Pub. Date: Aug. 21, 2008

(54) FIXING DEVICE, HEATING CONTROL METHOD

(75) Inventor: Takayuki Nishi, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/676,336

(22) Filed: Feb. 19, 2007

(51) Int. Cl. G03G 15/20

(52) U.S. Cl. 399/69; 399/70

(57) ABSTRACT

A technique is provided that enables extension of the life of an auxiliary power source by efficiently using the power of the auxiliary power source and thereby reducing the fixing temperature raising time and effectively restraining the lowering of the fixing temperature in an image forming apparatus having a fixing device. A fixing device is provided in an image forming apparatus and it can switch execution of a first heating mode for performing heating processing using a regular power source and a second heating mode for performing heating processing with a larger quantity of heating per unit time than in the first heating mode by using an auxiliary power source in addition to the regular power source. The fixing device includes: a heating mode determining unit configured to determine whether the heating processing in the second heating mode needs to be performed when performing heating processing, on the basis of predetermined information related to processing executed in the image forming apparatus; and a heating mode control unit configured to cause the heating processing in the first heating mode to be executed when it is determined by the heating mode determining unit that the heating processing in the second heating mode is not necessary, and to cause the heating processing in the second heating mode to be executed when it is determined that the heating processing in the second heating mode is necessary.

### BACKGROUND OF THE INVENTION

1. Field of the Invention

The present invention relates to heating control in a fixing device that performs fixing processing of a developer to a sheet.

2. Description of the Related Art

Traditionally, as an image forming apparatus having a fixing device, a machine type has been known that temporarily increases the power to be provided to the fixing device by utilizing the power of an auxiliary power source for the purpose of reducing the warm-up time and restraining the lowering of the fixing temperature at the time of image forming processing.

To use the auxiliary power source in the traditional image forming apparatus, the auxiliary power source has to be charged. In the case of supplying power from the auxiliary power source to the fixing device as described above, the charging work for the auxiliary power source must be carried out frequently.

Also, the life of the auxiliary power source is shorted by the repeated charging.

### SUMMARY OF THE INVENTION

An object of an embodiment of the present invention is to provide a technique that enables extension of the life of the auxiliary power source by efficiently using the power of the auxiliary power source and thereby reducing the fixing temperature raising time and effectively restraining the lowering of the fixing temperature in an image forming apparatus having a fixing device.

To address the above-described problems, a fixing device according to an embodiment of the invention is a fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source. The fixing device includes: a heating mode determining unit configured to determine whether the heating processing in the second heating mode needs to be performed when performing heating processing, on the basis of predetermined information related to processing executed in the image forming apparatus; and a heating mode control unit configured to cause the heating processing in the first heating mode to be executed when it is determined by the heating mode determining unit that the heating processing in the second heating mode is not necessary, and to cause the heating processing in the second heating mode to be executed when it is determined that the heating processing in the second heating mode is necessary.

Also, a fixing device according to an embodiment of the invention is a fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source. The fixing device includes: heating mode determining means for determining whether the heating processing in the second heating mode needs to be performed when performing heating processing, on the basis of predetermined information related to processing executed in the image forming apparatus; and heating mode control means for causing the heating processing in the first heating mode to be executed when it is determined by the heating mode determining means that the heating processing in the second heating mode is not necessary, and for causing the heating processing in the second heating mode to be executed when it is determined that the heating processing in the second heating mode is necessary.

A heating control method according to an embodiment of the invention is a heating control method to be executed in a fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source. The method includes: determining whether the heating processing in the second heating mode needs to be performed when performing heating processing, on the basis of predetermined information related to processing executed in the image forming apparatus; and causing the heating processing in the first heating mode to be executed when it is determined that the heating processing in the second heating mode is not necessary, and causing the heating processing in the second heating mode to be executed when it is determined that the heating processing in the second heating mode is necessary.

### DESCRIPTION OF THE DRAWINGS

FIG. 1 is a sectional view showing a basic configuration of an image forming apparatus having a fixing device according to the embodiment.

FIG. 2 is a functional block diagram for explaining the image forming apparatus having the fixing device according to the embodiment.

FIG. 3 is a flowchart for explaining a flow of processing in the fixing device according to the embodiment.

### DESCRIPTION OF THE EMBODIMENTS

Hereinafter, an embodiment of the invention will be described with reference to the drawings.

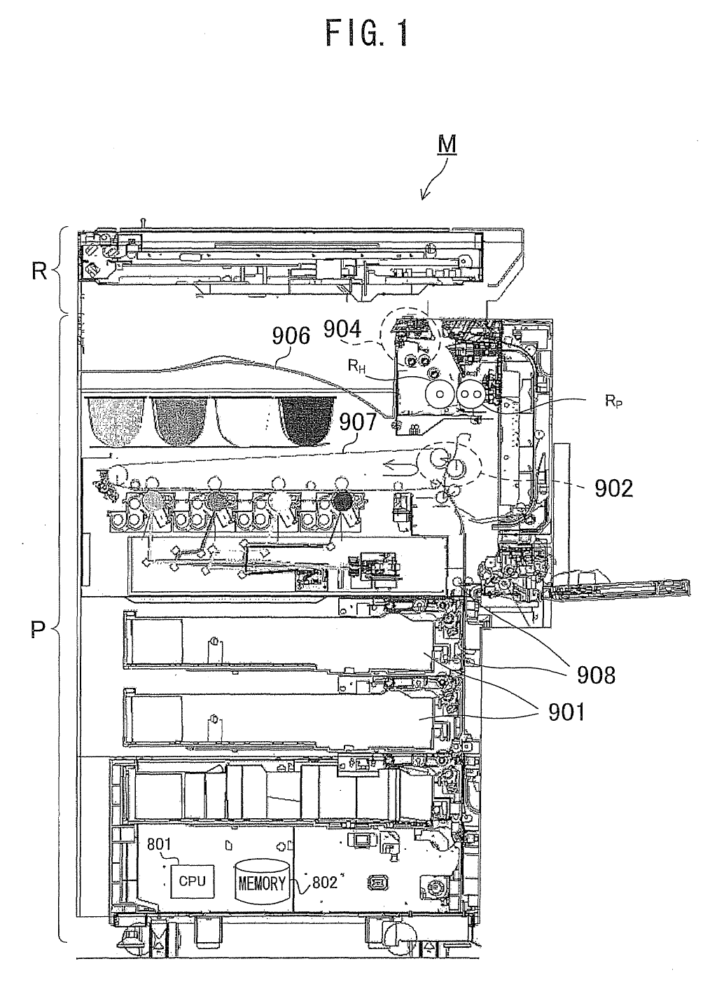

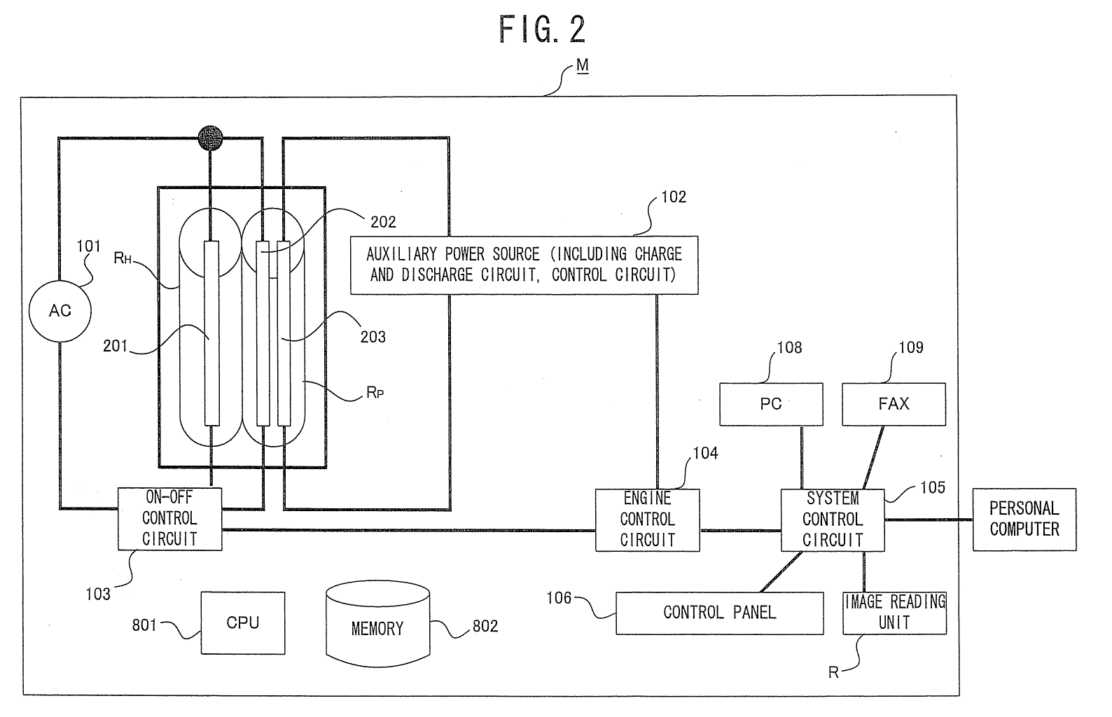

FIG. 1 is a sectional view showing a basic configuration of an image forming apparatus having a fixing device according to this embodiment. FIG. 2 is a functional block diagram for explaining the image forming apparatus having the fixing device according to this embodiment.

As shown in FIG. 1 and FIG. 2, an image forming apparatus M according to the embodiment has an image reading unit R that reads an image of an original, and an image forming unit P that forms a desired image on a sheet.

In the image forming unit P, first, a sheet is supplied from a paper cassette 901 to plural carrier rollers (carrier unit or carrier means) 908 that form a sheet carrier path. Toner transferred onto an intermediate transfer belt 907 is transferred to the sheet carried by the carrier rollers 908 (see a secondary transfer position 902).

The sheet to which the toner image has been transferred is carried to a fixing device having a heat roller R_{H} and a press roller R_{P}. The toner image is heated and fixed thereon by the fixing device.

The sheet on which the toner image has been fixed by the fixing device is discharged onto a discharge tray 906 by a paper discharge unit 904 formed by paper discharge rollers and the like.

Now, the configuration of the fixing device according to the embodiment will be described in detail.

The fixing device according to the embodiment can switch execution of a “first heating mode” for performing heating processing using a regular power source 101 such as an AC power source and a “second heating mode” for performing heating processing with a larger quantity of heating per unit time than in the first heating mode by using an auxiliary power source 102 such as a rechargeable battery in addition to the regular power source 101.

The fixing device according to the embodiment has the heat roller R_{H} and the press roller R_{P} that nip a sheet to which a toner image is to be fixed by heating. Here, in the “first heating mode”, a lamp 201 (approximately 900 W) and a lamp 202 (approximately 300 W) are heated using the regular power source 101, thereby heating the heat roller R_{H} and the press roller R_{P}. In the “second heating mode”, a lamp 203 (approximately 500 W) is heated using the auxiliary power source 102 in addition to heating the heat roller R_{H} and the press roller R_{P} by heating the lamp 201 and the lamp 202 by using the regular power source 101. Thus, the press roller R_{P} is heated further.

In this manner, with the configuration in which the auxiliary lamp is arranged near the press roller R_{P}, the heater housing space of the press roller R_{P} is utilized, which has more room than the heater housing space of the heat roller R_{H} where a heat must be originally arranged. Thus, it can contribute to overall saving of the space in the device.

Although the lamps are used here as heat sources for heating the respective rollers, the heat sources are not limited to these, and other heat sources such as IH may be used. Also, the lamp heated by using the auxiliary power source 102 may be arranged near the heat roller R_{H}.

A system control circuit 105 (equivalent to a heating mode determining unit or heating mode determining means) determines whether heating processing in the “second heating mode” needs to be carried out when performing heating processing using the heat roller R_{H} and the press roller R_{P}, on the basis of predetermined information (such as the content of execution of processing, state of execution of processing, and status of the device when executing processing) related to warm-up processing, print processing, copy processing and the like to be executed in the image forming apparatus M, acquired by communication with a control panel 106, the image reading unit R, a printer controller (PC) 108, a facsimile communication unit 109 and the like.

An engine control circuit 104 and an ON-OFF control circuit 103 (which are equivalent to a heating mode control unit or heating mode control means) cause the heating processing in the first heating mode to be executed when it is determined by the system control circuit 105 that the heating processing in the second heating mode is not necessary, and cause the heating processing in the second heating mode to be executed when it is determined that the heating processing in the second heating mode is necessary.

A CPU 801 serves to carry out various processing in the image forming apparatus M and also serves to realize various functions by executing programs stored in a memory 802. The memory 802 is formed by, for example, a ROM or RAM, and serves to store various information and programs to be used in the image forming apparatus.

Next, the operation of the fixing device in the image forming apparatus M according to the embodiment will be described.

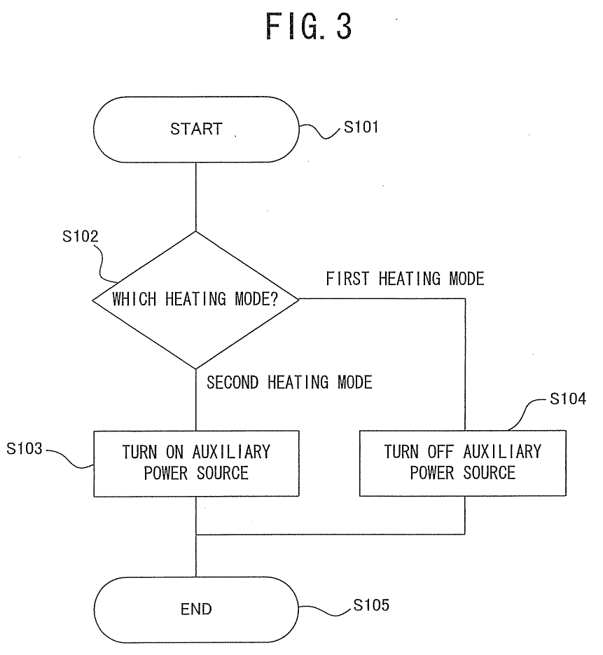

FIG. 3 is a flowchart for explaining a flow of processing in the fixing device according to the embodiment.

In the case of performing heating processing using the heater in the fixing device, when heating processing for executing at least one of a continuous print operation for a predetermined number of sheets or more in the image forming unit P, a copy operation, a return operation from a sleep state to a standby state, and an image forming operation to a sheet having a predetermined length or more in the carrying direction (an A3-size sheet, or a special sheet like a 1200-mm long sheet), is to be carried out, the system control circuit 105 determines whether the heating processing in the second heating mode needs to be carried out (S101, S102). The “sleep state” referred to here is the state where the heater is off, and the “standby state” is the state where a fixation-enabled temperature has been reached.

Here, the purpose of using the second heating mode when carrying out a continuous print operation for a predetermined number of sheets or more is to prevent degradation of image quality due to the lowering of the fixing temperature which occurs as the heat is removed by the sheet if the auxiliary power source is not used when a large number of copies or print sheets (for example, 100 print sheets or more) is to be made. Also, the purpose of using the second heating mode at the time of warm-up for carrying out a copy operation is to achieve a ready state as quickly as possible so that a printing result can be outputted as soon as possible because the user is most likely to be near the image forming apparatus M when performing copy processing. Moreover, the reason for using the second heating mode when forming an image to a sheet having a predetermined length or more in the carrying direction is that, when printing onto such a long sheet, the fixing temperature of the roller is largely removed by the sheet and it leads to the lowering of the fixing temperature.

On the other hand, in the case of performing heating processing using the heater in the fixing device, when heating processing for executing at least one of a warm-up operation for turning on the power source in accordance with weekly timer setting, a print operation based on image data from an external device such as a personal computer, a facsimile receiving operation, a return operation from the sleep state to the standby state when performing image forming processing onto a sheet that requires a predetermined value of power or more for printing, and an image forming operation to the second side when performing double-side print, is to be carried out, the system control circuit 105 determines that the heating in the second heating mode is not necessary (the heating processing in the first heating mode is to be carried out) (S102).

Here, the reason for using the first heating mode at the time of warm-up for turning on the power source in accordance with weekly timer setting, at the time of the print operation, and at the time of the facsimile receiving operation, is that the user is most likely to be away from the image forming apparatus at the time of these operations and therefore not to use the image forming apparatus immediately. Also, the reason for using the first heating mode at the time of the return operation for a sheet (cardboard) that requires more power for printing is that power for printing is necessary (and the fixing temperature is quickly lowered) when the cardboard mode is set and therefore it is preferable to save the power of the auxiliary power source for printing. Moreover, the reason for using the first heating mod at the time of printing at least onto the second side in the case of double-side print is that the sheet which is to have an image formed on its second side first passes through the fixing device once and then is carried to the fixing device again and therefore the sheet temperature at the time of fixing processing is high and the fixing temperature is not easily lowered. Thus, a sufficient fixing temperature can be reached even if heating is done in the first heating mode.

Also, the system control circuit 105 determines that the heating processing in the second heating mode need not be carried out when the temperature of at least one of the heat roller R_{H} and the press roller R_{P} is a predetermined temperature or higher at the time of warm-up. This is because the warm-up processing can be completed immediately if the temperature of one of the two rollers is a certain temperature or higher and therefore the quick heating in the second heating mode need not be carried out.

In the case where the system control circuit 105 (equivalent to a supply availability determining unit) determines whether power supply by the auxiliary power source 102 is available or not and it is determined by the system control circuit 105, in accordance with the engine control circuit 104 and the ON-OFF control circuit 103, that the heating processing in the second heating mode needs to be carried out, when the auxiliary power source 102 is in a state where it cannot supply power, the heating processing in the first heating mode can be executed. Here, the “state where it cannot supply power” means, for example, the state where the auxiliary power source is insufficiently charged, the state where the rechargeable battery is not loaded on the body of the image forming apparatus, and so on. Whether it is sufficiently charged or not can be determined by detecting, with a detector, the voltage value of the battery as the auxiliary power source and comparing the detected value with a predetermined voltage value (threshold value).

Moreover, whether the auxiliary power source is not loaded on the body of the image forming apparatus can be determined, for example, by the fact that the voltage value detected by the detector is 0 V, or by detection with a mechanical sensor (switch or the like) installed in the body of the image forming apparatus.

At the time of returning from the preheating state to the standby state in the image forming apparatus M or at the time of returning from the sleep state to the standby state, if execution of an operation mode of higher priority is designated, the second heating mode may be executed (the priority rank of this operation mode is preset). In this case, for example, if priority is given in the order of (1) the copy operation, (2) the print operation, and (3) the facsimile receiving operation, the second heating mode is executed only in the case of performing heating processing for executing the copy operation. Here, the “preheating state” means the state where the temperature is maintained between the temperature at which the heater is off and the fixation-enabled temperature.

Also, if the temperature of each roller of the fixing device when starting up the image forming apparatus M is detected (temperature information detected by the temperature sensor is acquired by the system control circuit 105) and it is a predetermined temperature or higher, it is determined that warm-up will end immediately, and the heating processing in the first heating mode can be executed.

Also, if the number of remaining print sheets and the fixing temperature are compared at the time of copying or printing during the print operation in the image forming apparatus M and it is determined that, even with the number of remaining sheets, the temperature is not lowered to a temperature at which a fixing defect or a fixation waiting state occurs, the heating processing in the first heating mode may be executed.

Moreover, when carrying out monochrome print, the heating processing in the first heating mode is executed because the fixing ability is higher than in color print. On the other hand, when carrying out color print, the heating processing in the second heating mode is executed.

The timing of executing the heating processing in the second heating mode can vary within a range from the start point of the heating processing to when the fixing temperature has reached a certain temperature.

Also, the switching of the execution of the heating processing in the first heating mode and the heating processing in the second heating mode can be arbitrarily set in accordance with the various operations such as the copy operation, the print execution, and the facsimile receiving operation (it can be changed to execute the heating processing in the second heating mode during the print operation, and so on).

The respective steps in the processing (heating control method) in the above-described image forming apparatus are realized by causing the CPU 801 to execute a heating control program stored in the memory 802.

In this manner, according to the embodiment, since the number of times the battery of the auxiliary power source is charged can be reduced, the life of the battery can be extended. Also, as the number of times of charging is reduced, the overall power consumed by the image forming apparatus can be reduced. Also, as the number of times the auxiliary power source is charged is reduced, the charging time can be shortened. Moreover, since the use or non-use of the auxiliary power source can be determined in accordance with the processing status, stable image formation can be carried out and it can contribute to reduction in the standby time. That is, in the image forming apparatus equipped with the auxiliary power source, it is possible to quickly warm up the device by using the power from the auxiliary power source at the time of warm-up or print, and to reduce the lowering of the fixing temperature at the time of continuous printing.

As the auxiliary power source used in the embodiment, for example, a secondary battery or the like is employed. However, the auxiliary power source is not limited to this and what can be used as an auxiliary power source can be used, such as a capacitor.

In the embodiment, the case where the functions to carry out the invention have been recorded in advance within the device is described, but these functions are not limited to this form. The similar functions can be downloaded to the device from a network, or a recording medium storing the similar functions can be installed in the device. The recording medium may be in any form, such as CD-ROM, as long as it can store the programs and can be read by the device. Also, the functions provided in advance by installing or downloading may also be realized in cooperation with the operating system (OS) or the like in the device.

While the present invention has been described in detail by using the specific embodiment, it is obvious to those skilled in the art that various changes and modifications can be made without departing from the spirit and scope of the invention.

As described above in detail, according to the embodiment, a technique can be provided that enables extension of the life of the auxiliary power source by efficiently utilizing the power of the auxiliary power source and thereby reducing the fixing temperature raising time and effectively restraining the lowering of the fixing temperature in the image forming apparatus having the fixing device.

What is claimed is:

1. A fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source, the fixing device comprising:
a heating mode determining unit configured to determine whether the heating processing in the second heating mode needs to be performed when performing heating processing, on the basis of predetermined information related to processing executed in the image forming apparatus; and
a heating mode control unit configured to cause the heating processing in the first heating mode to be executed when it is determined by the heating mode determining unit that the heating processing in the second heating mode is not necessary, and to cause the heating processing in the second heating mode to be executed when it is determined that the heating processing in the second heating mode is necessary.

2. The fixing device according to claim 1, wherein the heating mode determining unit determines that the heating processing in the second heating mode need to be carried out when performing heating processing for executing at least one of a continuous print operation for a predetermined number of sheets or more, a copy operation, a return operation to a standby state, and an image forming operation to a sheet having a predetermined length or more in a carrying direction.

3. The fixing device according to claim 1, wherein the heating mode determining unit determines that the heating processing in the second heating mode need not be carried out when performing heating processing for executing at least one of a warm-up operation for turning on a power source in accordance with weekly timer setting, a print operation based on data from an external device, a facsimile receiving operation, a return operation for a sheet that requires a predetermined value of power or more at the time of printing, and an image forming operation to a second side in the case of performing double-side print.

4. The fixing device according to claim 1, comprising a heat roller and a press roller that nip a sheet on which a toner image is to be fixed by heating in the fixing device,
wherein the heating mode determining unit determines that the heating processing in the second heating mode need not be carried out when the temperature of at least one of the heat roller and the press roller at the time of warm-up is a predetermined temperature or higher.

5. The fixing device according to claim 1, comprising a supply availability determining unit configured to determine availability of power supply from the auxiliary power source,
wherein the heating mode control unit causes the heating processing in the first heating mode to be executed when power supply from the auxiliary power source is unavailable in the case where it is determined by the heating mode determining unit that the heating processing in the second heating mode needs to be carried out.

6. The fixing device according to claim 1, comprising a heat roller and a press roller that nip a sheet on which a toner image is to be fixed by heating in the fixing device,
wherein the first heating mode is for heating the heat roller and the press roller by using the regular power source, and
the second heating mode is for further heating the press roller by using the auxiliary power source in addition to heating the heat roller and the press roller by using the regular power source.

7. The fixing device according to claim 1, wherein the auxiliary power source is a battery.

8. A fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source, the fixing device comprising:
heating mode determining means for determining whether the heating processing in the second heating mode needs to be performed when performing heating processing, on the basis of predetermined information related to processing executed in the image forming apparatus; and
heating mode control means for causing the heating processing in the first heating mode to be executed when it is determined by the heating mode determining means that the heating processing in the second heating mode is not necessary, and for causing the heating processing in the second heating mode to be executed when it is determined that the heating processing in the second heating mode is necessary.

9. The fixing device according to claim 8, wherein the heating mode determining means determines that the heating processing in the second heating mode need to be carried out when performing heating processing for executing at least one of a continuous print operation for a predetermined number of sheets or more, a copy operation, a return operation to a standby state, and an image forming operation to a sheet having a predetermined length or more in a carrying direction.

10. The fixing device according to claim 8, wherein the heating mode determining means determines that the heating processing in the second heating mode need not be carried out when performing heating processing for executing at least one of a warm-up operation for turning on a power source in accordance with weekly timer setting, a print operation based on data from an external device, a facsimile receiving operation, a return operation for a sheet that requires a predetermined value of power or more at the time of printing, and an image forming operation to a second side in the case of performing double-side print.

11. The fixing device according to claim 8, comprising a heat roller and a press roller that nip a sheet on which a toner image is to be fixed by heating in the fixing device,
wherein the heating mode determining means determines that the heating processing in the second heating mode need not be carried out when the temperature of at least one of the heat roller and the press roller at the time of warm-up is a predetermined temperature or higher.

12. The fixing device according to claim 8, comprising supply availability determining means for determining availability of power supply from the auxiliary power source,
wherein the heating mode control means causes the heating processing in the first heating mode to be executed when power supply from the auxiliary power source is unavailable in the case where it is determined by the heating mode determining means that the heating processing in the second heating mode needs to be carried out.

13. The fixing device according to claim 8, comprising a heat roller and a press roller that nip a sheet on which a toner image is to be fixed by heating in the fixing device,
wherein the first heating mode is for heating the heat roller and the press roller by using the regular power source, and
the second heating mode is for further heating the press roller by using the auxiliary power source in addition to heating the heat roller and the press roller by using the regular power source.

14. The fixing device according to claim 8, wherein the auxiliary power source is a battery.

15. A heating control method to be executed in a fixing device that is provided in an image forming apparatus and that can switch execution of a first heating mode for performing heating processing using a regular power source and a second heating mode for performing heating processing with a larger quantity of heating per unit time than in the first heating mode by using an auxiliary power source in addition to the regular power source, the method comprising:
determining whether the heating processing in the second heating mode needs to be performed when performing heating processing, on the basis of predetermined information related to processing executed in the image forming apparatus; and
causing the heating processing in the first heating mode to be executed when it is determined that the heating processing in the second heating mode is not necessary, and causing the heating processing in the second heating mode to be executed when it is determined that the heating processing in the second heating mode is necessary.

16. The heating control method according to claim 15, wherein it is determined that the heating processing in the second heating mode need to be carried out when performing heating processing for executing at least one of a continuous print operation for a predetermined number of sheets or more, a copy operation, a return operation to a standby state, and an image forming operation to a sheet having a predetermined length or more in a carrying direction.

17. The heating control method according to claim 15, wherein it is determined that the heating processing in the second heating mode need not be carried out when performing heating processing for executing at least one of a warm-up operation for turning on a power source in accordance with weekly timer setting, a print operation based on data from an external device, a facsimile receiving operation, a return operation for a sheet that requires a predetermined value of power or more at the time of printing, and an image forming operation to a second side in the case of performing double-side print.

18. The heating control method according to claim 15, wherein it is determined that the heating processing in the second heating mode need not be carried out when the temperature of at least one of the heat roller and the press roller at the time of warm-up is a predetermined temperature or higher.

19. The heating control method according to claim 15, wherein availability of power supply from the auxiliary power source is determined, and
the heating processing in the first heating mode is caused to be executed when power supply from the auxiliary power source is unavailable in the case where it is determined that the heating processing in the second heating mode needs to be carried out.

20. The heating control method according to claim 15, wherein the auxiliary power source is a battery.
